(19) United States
(12) Patent Application Publication
(10) Pub. No.: US 2012/0100817 A1
(43) Pub. Date: Apr. 26, 2012

(54) LOADING OF A TWISTED FOLDED-MONOPOLE

(75) Inventors: Aviv Schachar, Ramat-Gan (IL); Shimon Barness, Matan (IL); Dean La Rosa, Bohemia, NY (US); Roni Shamsian, Holon (IL)

(73) Assignee: Motorola, Inc., Schaumburg, IL (US)

(21) Appl. No.: 12/912,068

(22) Filed: Oct. 26, 2010

(51) Int. Cl. H04W 88/02; H01Q 5/01; H01Q 1/48; H01Q 1/36

(52) U.S. Cl. 455/73; 343/700 MS; 343/843; 343/848

(57) ABSTRACT

A loading of a twisted folded monopole (LTFM) includes a first antenna portion and a second antenna portion. The first and second antenna portions are mutually coupled to support a lower band for wireless communications. The LTFM also includes a third antenna portion and a fourth antenna portion. The third and fourth antenna portions generate self resonance in a higher band for wireless communications.

### BACKGROUND

An antenna may be used with electronic devices to enable wireless communications. The configuration of the antenna may determine a type of wireless communication such as a frequency range in which signals may be received and transmitted. In a first example, a conventional folded-monopole antenna may be used for medium wave amplitude modulation by being configured with a one-quarter wavelength. In a second example, an inverted L-antenna may be used for a variety of different frequency ranges by being configured with a 35% wavelength. In a third example, a J-antenna may be an end-fed omnidirectional dipole antenna by being configured with a one-half wavelength.

Wireless communications have been growing continuously, particularly in standards for mobile devices. For example, Long Term Evolution (LTE), which is a new high performance air interface for cellular mobile communication systems that is a last step toward a 4^{th} generation (4G), has been approved and may soon be implemented on a larger scale. LTE enables unprecedented performance in terms of peak data rates, delay, spectrum efficiency and channel capacity of mobile telephone networks.

With new standards for wireless communications, the antenna for electronic devices requires a configuration that enables signals to be transmitted/received at the new standards. For example, LTE is based on multi-antenna technologies such as multiple-input and multiple output (MIMO). Conventional antennas may accommodate one type of wireless communication, but may not be properly configured for other types of wireless communications. Furthermore, antenna design is markedly affected by mobile device design that is generally geared as a small product, thereby requiring the antenna design to be allocated a small antenna area and volume while exhibiting other factors such as correlation-coefficient, radiation performance, isolation, etc.

### SUMMARY OF THE INVENTION

The exemplary embodiments describe a loading of a twisted folded monopole (LTFM). The LTFM comprises a first antenna portion and a second antenna portion. The first and second antenna portions are mutually coupled to support a lower band for wireless communications. The LTFM comprises a third antenna portion and a fourth antenna portion. The third and fourth antenna portions generate self resonance in a higher band for wireless communications.

### DESCRIPTION OF THE DRAWINGS

FIG. 1 shows a loading of a twisted folded monopole according to an exemplary embodiment.

FIG. 1A shows a branch splitting for the loading of the twisted folded monopole of FIG. 1 according to an exemplary embodiment.

FIG. 2 shows a table of characteristics for a second element of the twisted folded monopole of FIG. 1 according to an exemplary embodiment.

FIG. 3 shows a table of characteristics for a first element of the twisted folded monopole of FIG. 1 according to an exemplary embodiment.

FIG. 4 shows a first perspective view of the loading of the twisted folded monopole of FIG. 1 according to an exemplary embodiment.

FIG. 5 shows a second perspective view of the loading of the twisted folded monopole of FIG. 1 according to an exemplary embodiment.

FIG. 5a shows the branch splitting of FIG. 1A with the first perspective view of the loading of the twisted folded monopole of FIG. 4 according to an exemplary embodiment.

FIG. 6 shows the loading of the twisted folded monopole with a ground plane according to an exemplary embodiment.

FIG. 7 shows results of a simulation for the loading of the twisted folded monopole with a first type of ground plane according to an exemplary embodiment.

FIG. 8 shows results of a simulation for the loading of the twisted folded monopole with a second type of ground plane according to an exemplary embodiment.

FIG. 9 shows results of a simulation for the loading of the twisted folded monopole with a third type of ground plane according to an exemplary embodiment.

FIG. 10 shows a distribution efficiency of the loading of a twisted folded monopole of FIG. 1 using the three types of ground planes of FIGS. 7-9 according to an exemplary embodiment.

FIG. 11 shows a peak-gain distribution for the loading of a twisted folded monopole of FIG. 1 using the three types of ground planes of FIGS. 7-9 according to an exemplary embodiment.

FIG. 12 shows a first printed balun with two loading of a twisted folded monopoles on opposite ends with slots disposed in a ground plane disposed between the monopoles according to an exemplary embodiment.

FIG. 13 shows an insertion-loss for the printed balun of FIG. 12 using the ground plane of FIG. 8 according to an exemplary embodiment.

FIG. 14 shows a second printed balun with two loading of a twisted folded monopoles on opposite ends with slots disposed perpendicularly to a ground plane disposed between the monopoles according to an exemplary embodiment.

FIG. 15 shows a mobile device that includes the printed balun of FIG. 12 according to an exemplary embodiment.

FIG. 15A shows the mobile device of FIG. 15 with the printed balun of FIG. 12 incorporated therein according to an exemplary embodiment.

FIG. 15B shows the mobile device of FIG. 15A with a functionality of the two loading of the twisted folded monopoles denoted according to an exemplary embodiment.

FIG. 16 shows a return-loss outcome for the mobile device of FIG. 15 according to an exemplary embodiment.

FIG. 17 shows a three dimensional pattern for the printed balun of FIG. 12 in a linear case according to an exemplary embodiment.

FIG. 18 shows a three dimensional pattern for the printed balun of FIG. 12 in a right hand circular polarization case according to an exemplary embodiment.

FIG. 19A-B show a mobile device with a modified printed balun with two loading of the twisted folded monopoles according to an exemplary embodiment.

FIG. 20 shows a measurement of a S-parameter magnitude for the modified printed balun of FIG. 19 according to an exemplary embodiment.

FIGS. 21A-H show a three dimensional radiation pattern for the modified printed balun of FIG. 19 at various wavelengths according to an exemplary embodiment.

### DETAILED DESCRIPTION

The exemplary embodiments may be further understood with reference to the following description and the appended drawings, wherein like elements are referred to with the same reference numerals. The exemplary embodiments describe an antenna design for a loading of a twisted folded-monopole (LTFM). Specifically, a folded monopole, also known as a narrowband balanced antenna, includes a single element of a quarter wavelength that further supports further bands by being equipped with additional elements. The LTFM including the folded monopole and the additional elements will be discussed in further detail below.

The LTFM may be designed with a new profile having a minimum volume which accounts for all bands such as Long Term Evolution (LTE) (having a frequency range between 698 MHz to 806 MHz), Global System for Mobile Communications (GSM) 850 (having a frequency range between 824 MHz to 894 MHz), GSM900 (having a frequency range between 880 MHz to 960 MHz), Data Coding Scheme (DCS) 1800 (having a frequency range between 1710 MHz to 1880 MHz), Partitioning Communication System (PCS) 1900 (having a frequency range between 1850 MHz to 1990 MHz), and Universal Mobile Telecommunications System (UMTS) 2100 (having a frequency range between 1920 MHz to 2170 MHz). Conventional antenna designs have difficulty supporting the 31.6% bandwidth (e.g., 262 MHz) in the lower band.

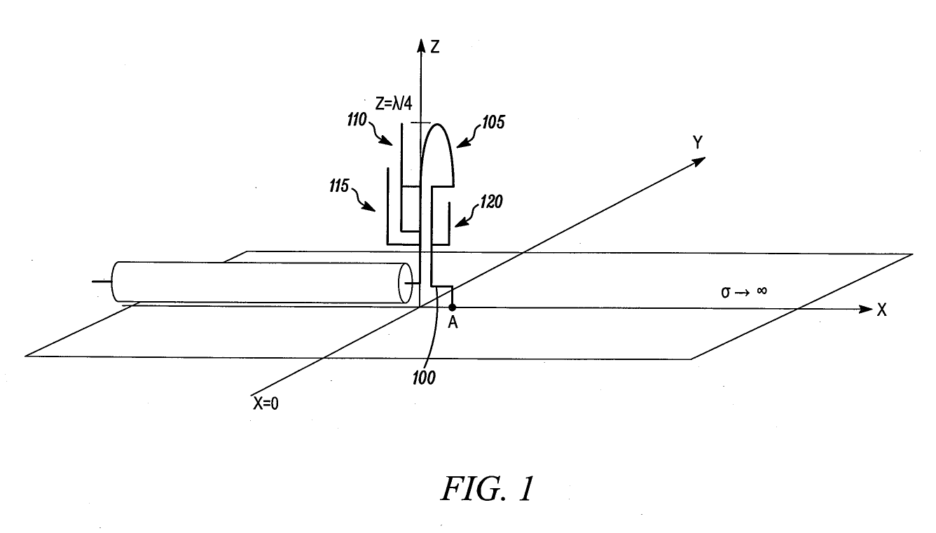

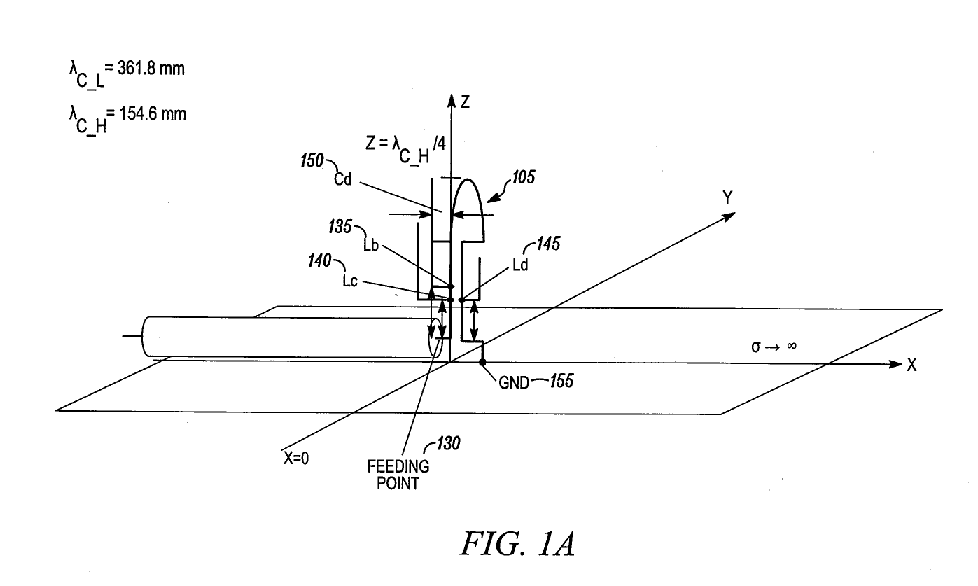

FIG. 1 shows a LTFM 100 according to an exemplary embodiment. Specifically, the LTFM 100 of FIG. 1 may be a constructive view. A detailed view of the LTFM 100 including a configuration and dimensions will be discussed in further detail below. As discussed above, the LTFM 100 may be a folded monopole with additional elements to support the bands in which wireless communications are used. The LTFM 100 may include a first element 105 (e.g., J antenna), a second element 110 (e.g., folded monopole), a third element 115 (e.g., inverted L antenna), and a fourth element 120 (e.g., folded monopole). The elements 105, 110, 115, and 120 may be based on a quarter wavelength for a respective band. Furthermore, the elements 105, 110, 115, 120 may be considered as a part of the complete bandwidth of the LTFM 100. FIG. 1A shows a branch splitting for the LTFM 100 of FIG. 1 according to an exemplary embodiment. The branch splitting will be discussed in further detail below.

The first element 105 and the second element 110 may be for the lower band while the third element 115 and the fourth element 120 may be for the higher band. Specifically, the elements 105 and 110 may support 31.6% bandwidth (e.g., 262 MHz) generated through mutual-coupling. The elements 115 and 120 may generate self resonance in the higher band to achieve 23.7% bandwidth (e.g., 460 MHz).

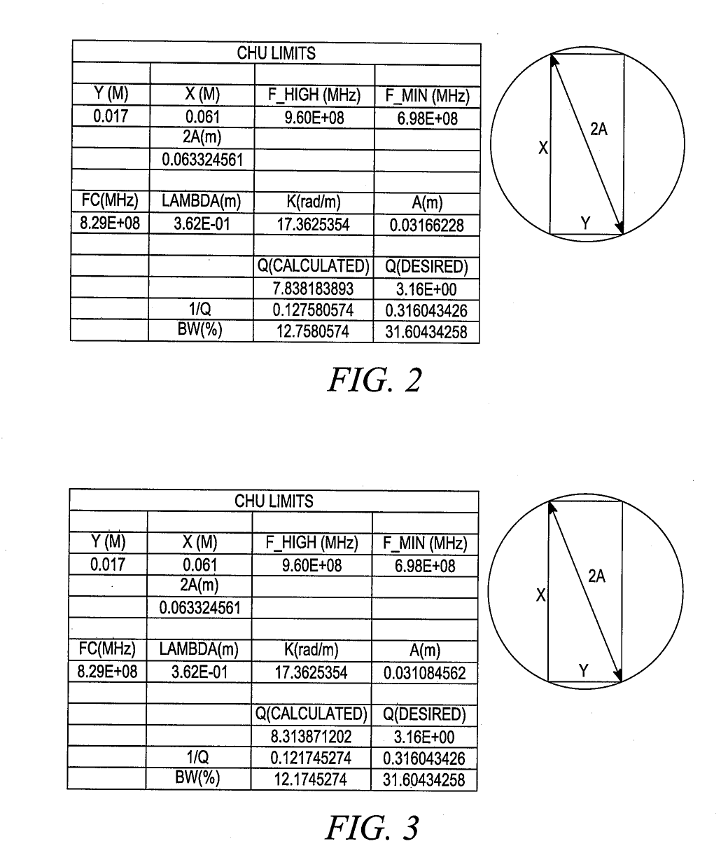

To generate the lower bandwidth using the first element 105 and the second element 110, the exemplary embodiment of the LTFM 100 may obtain the lower bandwidth using a structure that is capable of being enclosed within a sphere that has a radiated field discussed herein. FIG. 2 shows a table for the second element 110 including dimensions and characteristics given the dimensions for well known Chu limits. FIG. 2 includes calculations that illustrate that the total bandwidth for the second element 110 given the properties thereof generates a 12.75% bandwidth for a desired 31.6% bandwidth. FIG. 3 shows a table for the first element 105 including dimensions and characteristics given the dimensions for well known Chu limits. FIG. 3 includes calculations that illustrate that the total bandwidth for the first element 105 given the properties thereof also generates a 12.17% bandwidth for a desired 31.6% bandwidth. Therefore, the mutual-coupling of the first element 105 and the second element 110 results in a total bandwidth of 24.92% (12.75%+12.17%) with a bandwidth residue from the difference of the desired bandwidth (31.6%) and the total bandwidth (24.92%) being 6.68%.

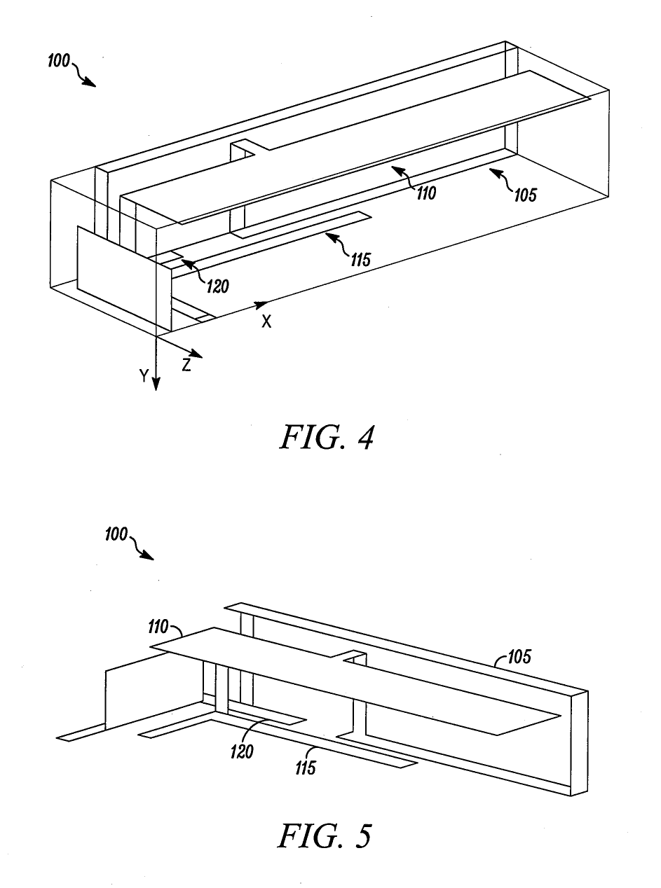

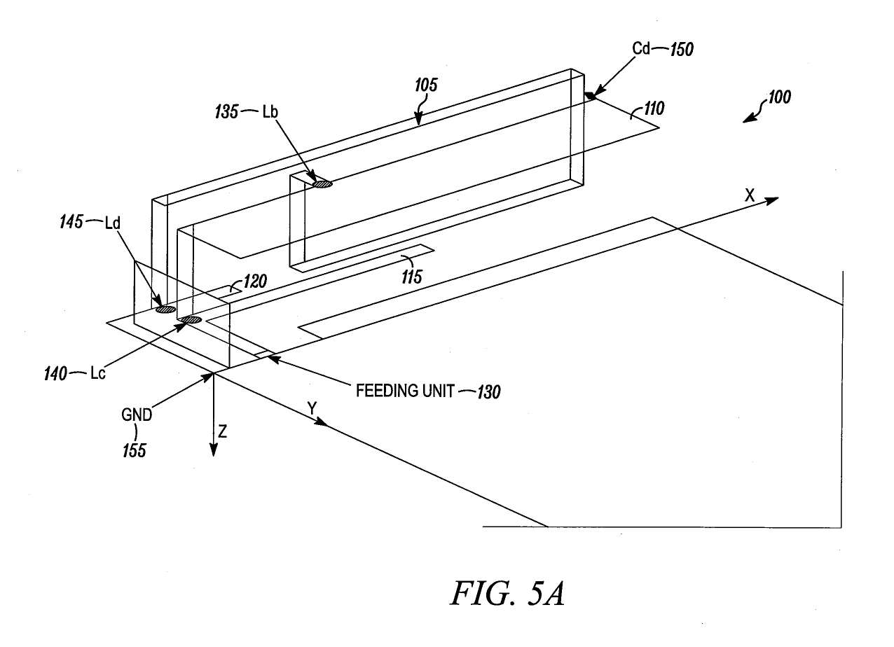

FIG. 4 shows a first perspective view of the LTFM 100 of FIG. 1. Specifically, the LTFM 100 of FIG. 4 illustrates an exemplary embodiment of an antenna adapted and configured to be incorporated with a mobile device (e.g., personal digital assistant, cellular phone, handheld devices, etc.). However, it should be noted that the LTFM 100 may also be adapted and configured for use with any electronic device that is capable of wireless communications. FIG. 5 shows a second perspective view of the LTFM 100 of FIG. 1.

As discussed above, the LTFM 100 may include the first element 105, the second element 110, the third element 115, and the fourth element 120. Also as discussed above, the first element 105 and the second element 110 may generate the lower bandwidth while the third element 115 and the fourth element 120 may generate the higher bandwidth. To properly provide the generation of the bandwidths, the elements 105, 110, 115, 120 require certain characteristics such as dimensions. Furthermore, the exemplary embodiment of the LTFM 100 may be configured so that the dimensions enable the LTFM 100 to be incorporated with a mobile device. For example, the LTFM 100 may have dimensions such as 61 mm by 17 mm by 12 mm. Therefore, in an exemplary embodiment, the dimensions of the LTFM 100 may be configured for the dimensions of the conventional mobile device. However, it should be noted that the dimensions of the LTFM 100 may be configured with different dimensions as a function of the dimensions of the mobile device or other electronic device that utilizes the LTFM 100.

As shown in FIGS. 4 and 5, a total length occupied by the LTFM 100 may be 61 mm; a total width occupied by the LTFM 100 may be 17 mm; and a total height occupied by the LTFM 100 may be 12 mm. The first element 105 may have a substantially similar shape of a folded-monopole that extends a substantial amount of the length and having a width of 2 mm. The second element 110 may have a rectangular shape and extend 55 mm in length with a 10 mm width. All other dimensions of the elements of the LTFM 100 may be, for example, 2 mm.

Referring back to FIG. 1A, the branch splitting of the may include a length for each element. Initially, those skilled in the art will understand that an antenna such as the LTFM 100 may include a feeding point 130 and a ground 155. The branch splitting of the LTFM 100 may enable the element independence from each other. The lengths Lb 135 and Lc 140 may be straight from the feeding point 130. The length Ld 145 may be accounted for as a function of the ground 155. The length Cd 150 may be a coupling distance. The dimensions of Lb 135, Lc 140, Ld 145, and Cd 150 may be based on center wavelengths of the lower band and the higher band. For example, if the focal length of the lower band is 829 MHz, the wavelength of the lower band may be determined as the speed of light (c) divided by the focal length. Thus, the wavelength of the lower band may be 361.8 mm. In another example, if the focal length of the upper band is 1940 MHz, the wavelength of the upper band may be determined as the speed of light c divided by the focal length. Thus, the wavelength of the upper band may be 154.6 mm. According to the exemplary embodiments, the length Lb 135 may be determined as the product of 0.11 times the wavelength of the lower band; the length Lc 140 may be determined as the product of 0.065 times the wavelength of the upper band; the length Ld 145 may be determined as the product of 0.15 times the wavelength of the upper band; and the length Cd 150 may be determined as the product of 0.0055 times the wavelength of the lower band.

FIG. 5a shows the branch splitting of FIG. 1A with the first perspective view of the LTFM 100 of FIG. 4 according to an exemplary embodiment. Specifically, FIG. 5A illustrates the lengths and dispositions of the branch splitting components described above with reference to FIG. 1A. Thus, the dispositions of the feeding point 130, the ground 155, the Lb 135, the Lc 140, the Ld 145, and the Cd 150 are shown with respect to the elements 105, 110, 115, and 120.

The LTFM 100 may be implemented using a variety of different technologies such as stamping-tin, tin made from Nickel-Silver, Flex Printed Circuit, Laser Direct Structure, etc. Flexible tuning of the first element 105 and the second element 110 may be used to control the lower band on the left and right side while the third element 115 and the fourth element 120 may be flexibly tuned for the higher band. Those skilled in the art will understand that the higher band may be expanded easily according to the required bandwidth. It should also be noted that, as discussed above, the dimensions of the LTFM 100 may be altered. For example, the dimensions may be made more compact such as having dimensions of 58 mm by 16 mm by 11 mm using a capacitance loaded configuration in which dielectric materials are used such as antenna holders from Polycarbonate-Lexan (e.g., EXL1414, EXL9335, etc.) with a ∈r value of 2.95 and a δ(loss) value of 0.0024 at least.

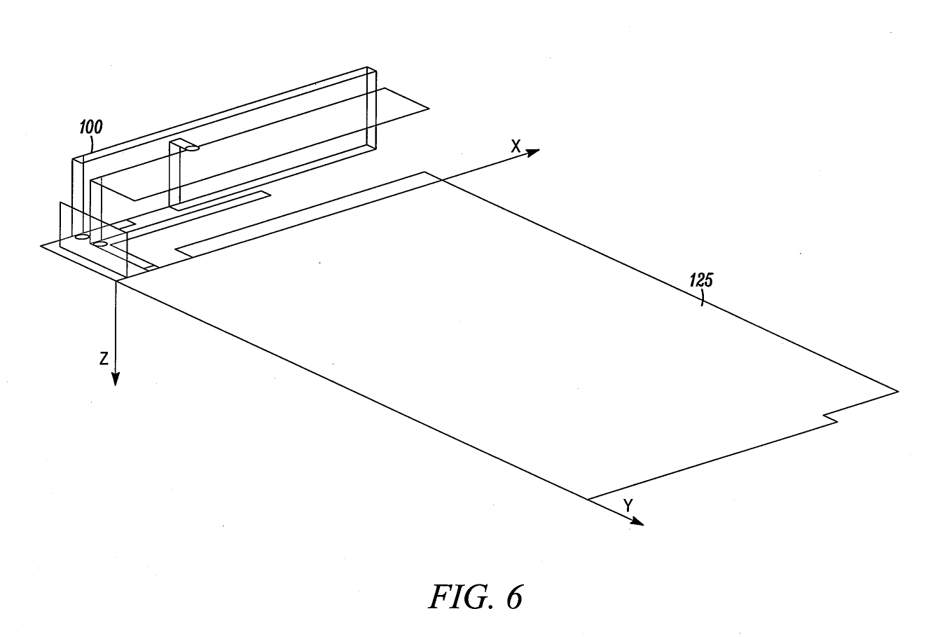

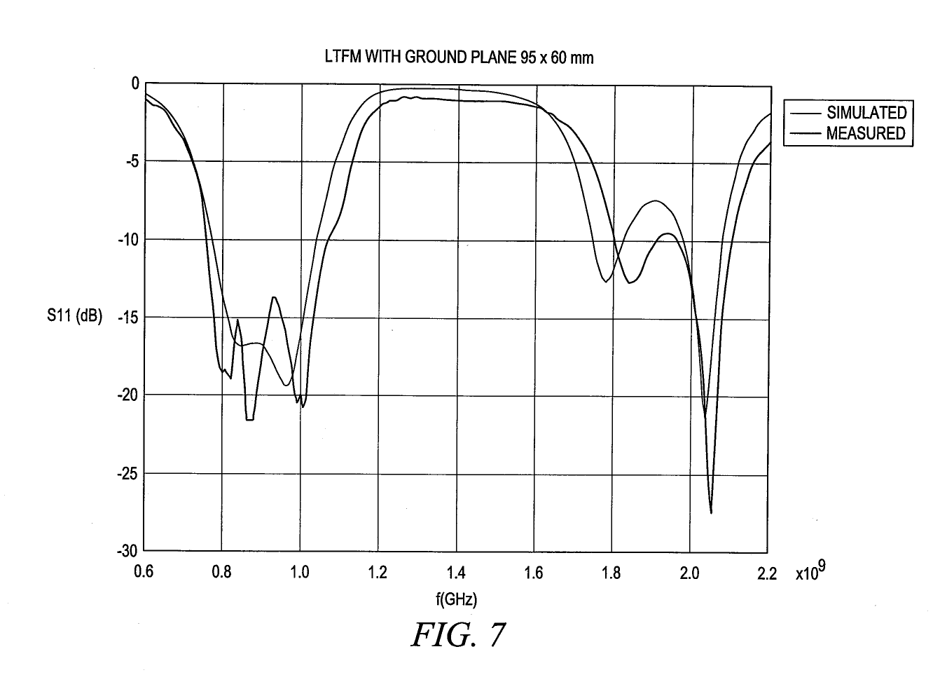

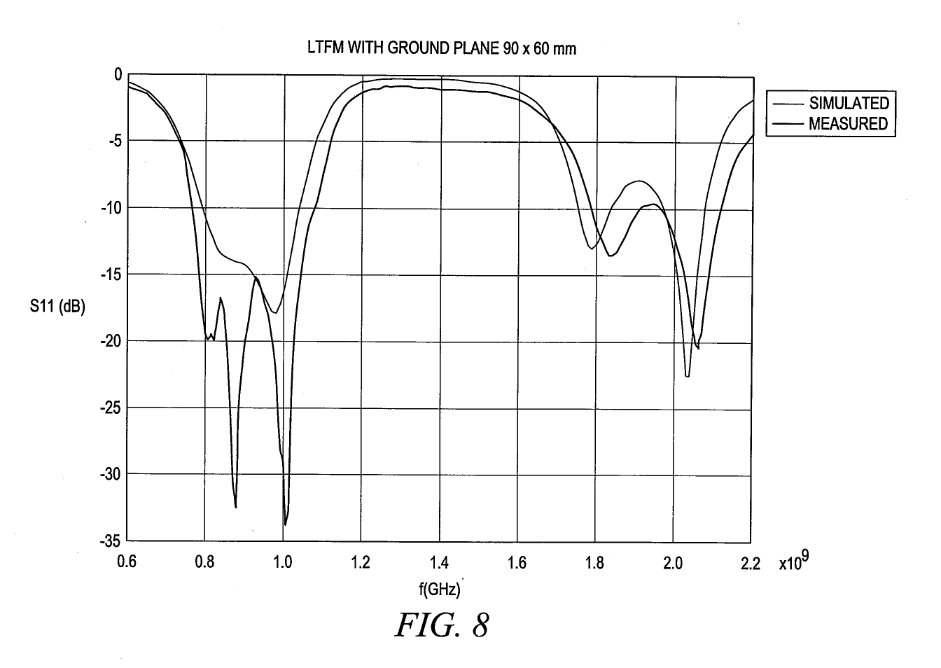

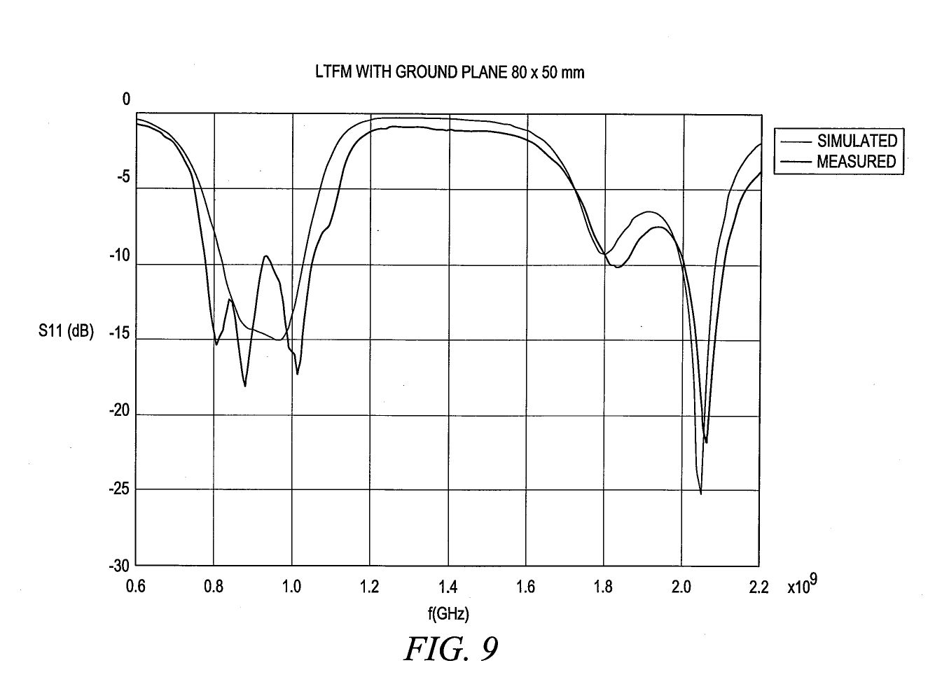

The exemplary LTFM 100 was tested using a variety of ground planes. FIG. 6 shows the LTFM 100 connected to a ground plane 125 for performing the testing. The testing may be performed using, for example, baluns with a network-analyzer (N5230A). The ground plane 125 may have dimensions of 95 mm by 60 mm. Further tests may be performed using other varieties of ground planes having, for example, dimensions of 90 mm by 60 mm, 80 mm by 50 mm, etc. FIG. 7 illustrates results for the LTFM 100 having the above described dimensions using the ground plane 125 having dimensions of 95 mm by 60 mm. Specifically, FIG. 7 shows S11 (e.g., power reflection on an antenna) results as a function of frequency measured in GHz. FIG. 8 illustrates results for the LTFM 100 having the above described dimensions using the ground plane 125 having dimensions of 90 mm by 60 mm. Specifically, FIG. 8 shows S11 results as a function of frequency measured in GHz. FIG. 9 illustrates results for the LTFM 100 having the above described dimensions using the ground plane 125 having dimensions of 80 mm by 50 mm. Specifically, FIG. 9 shows S11 results as a function of frequency measured in GHz.

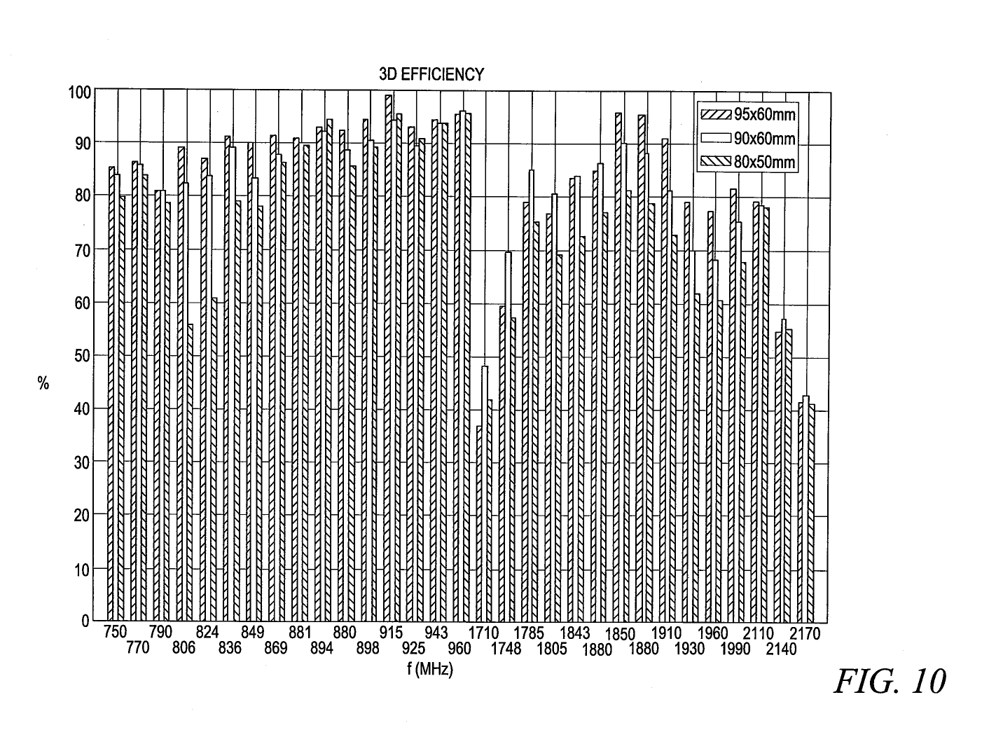

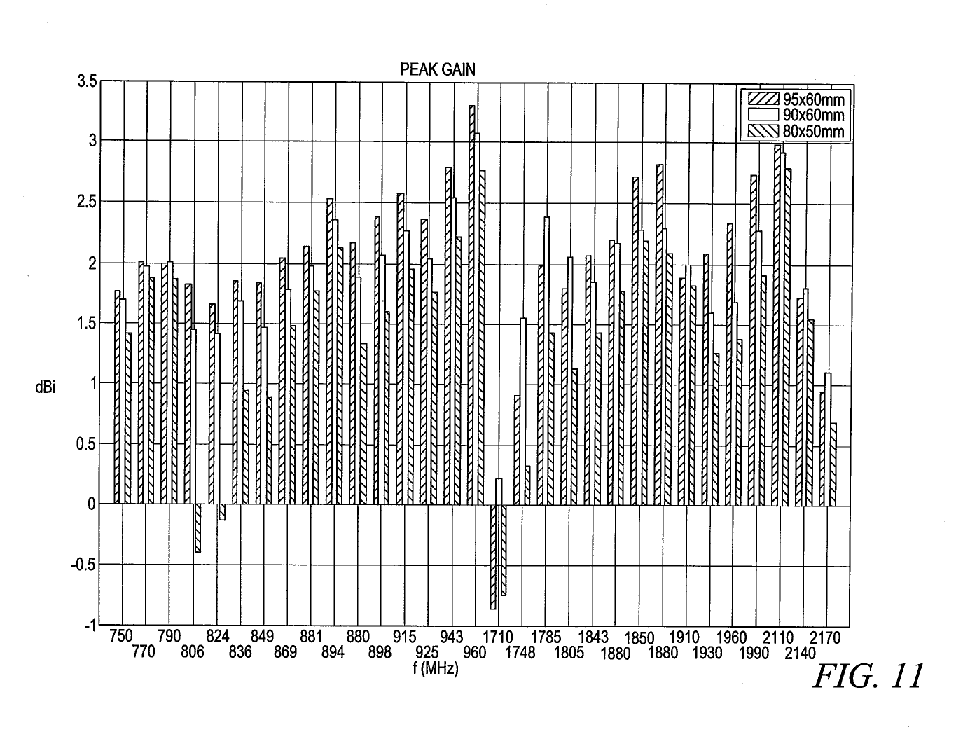

The LTFM 100 may further be simulated to measure efficiency. For example, the efficiency simulation may be performed in an anechoic-chamber using the three ground planes described above. The efficiency simulation may utilize various specifications such as frequency range, quiet zone size, max EUT weight, range length, quiet zone ripple, measurement uncertainty contribution, etc. FIG. 10 shows a distribution efficiency of the LTFM 100 with the three ground planes described above. Specifically, the distribution measures a percent efficiency as a function of frequency measured in MHz. Furthermore, the distribution efficiency may be measured using a frequency range between 750 MHz to 6 GHz, a quiet zone size of 12 in (30 cm), a max EUT weight of 100 lbs (45 kg), a range length of 48 ini (122 cm), a quiet zone ripple of ∀0.5 dB typical and ∀1.5 dB maximum, and a measurement uncertainty contribution of less than 0.3 dB at a 95% confidence.

The LTFM 100 may additionally be simulated to measure a peak gain distribution. FIG. 11 shows a peak-gain distribution for the LTFM 100 with the three ground planes described above. Specifically, FIG. 11 shows the dBi as a function of frequency in MHz.

For the implementation of the LFTM 100, the correlation coefficient (r) may be considered as a critical index for MIMO channel performance. The value of r is such that −1<r<+1 where the +/− signs are used for positive linear correlations and negative linear correlations, respectively. If there is no linear correlation or a weak linear correlation, the value of r may be close to 0. A value near zero means that there is a random, nonlinear relationship between the two variables. A perfect correlation of ∀1 occurs only when the data points all lie exactly on a straight line. If r=+1, the slope of the this line is positive while if r=−1, the slope of the this line is negative. Those skilled in the art will understand that a correlation value of greater than 0.8 is generally described as strong whereas a correlation value of less than 0.5 is generally described as weak. Therefore, if the correlation defined as strong hence, the system performance may degenerate to a single input and single output (SISO) channel. Consequently, the MIMO's contribution may be lost from a channel capacity aspect.

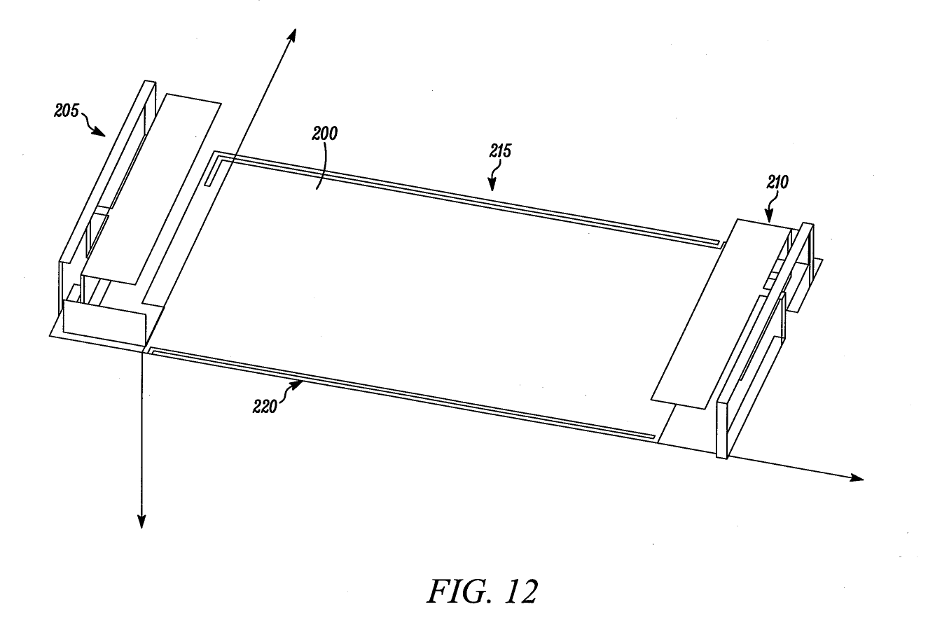

FIG. 12 shows a printed balun 200 in which quarter wavelength slots 215 and 220 are incorporated. On each end of the printed balun 200 may be a first LTFM 205 and a second LTFM 210. As will be described below, the printed balun 200 enables increasing the isolation between the LTFM 205 and the LTFM 210 as well as decreasing the correlation coefficient.

Upon running various simulations, the resultant data may be used to determine the isolation between the LTFM 205 and the LTFM 210 as well as the correlation coefficient. In a first exemplary simulation at, for example, 710 MHz and 770 MHz, the J behaviors of the J antenna component in each of the LTFM 205 and the LTFM 210 without the slots 215 and 220 incorporated on the printed balun 200 may be used. In a second exemplary simulation at, for example, 710 MHz and 770 MHz, the J behaviors of the J antenna component in each of the LTFM 205 and the LTFM 210 with the slots 215 and 220 incorporated on the printed balun 200 may be used. In a third exemplary simulation at, for example, 710 MHz and 770 MHZ, the E-Field behaviors of the LTFM 205 and the LTFM 210 with the slots 215 and 220 incorporated on the printed balun 200 may be used.

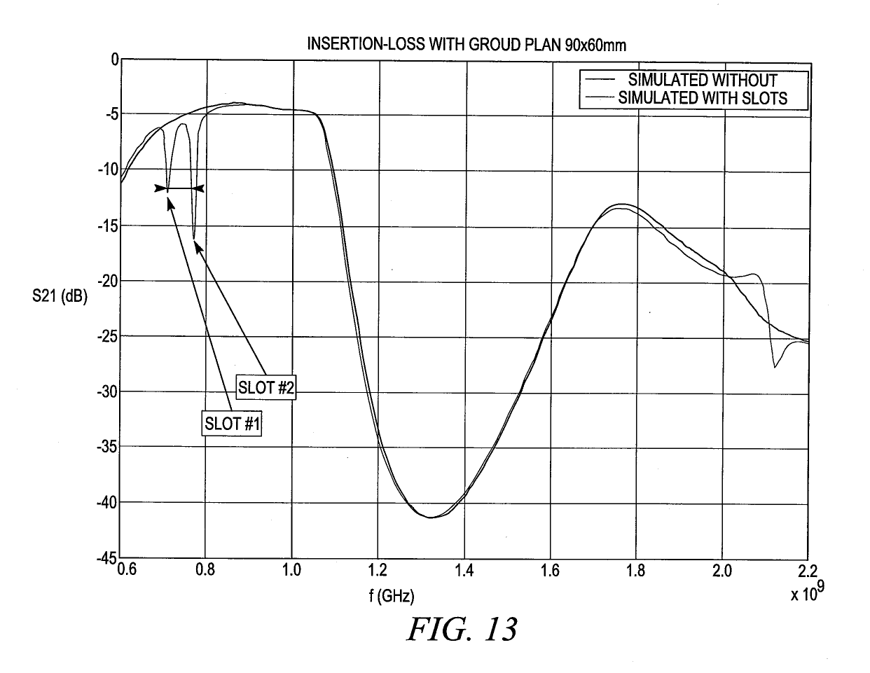

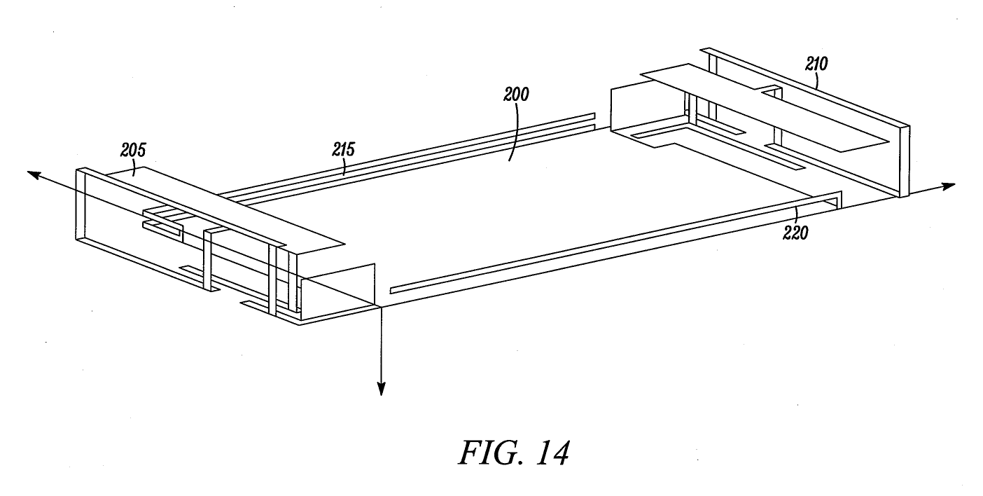

FIG. 13 shows an insertion-loss using a ground plane having dimensions of 90 mm by 60 mm. Specifically, FIG. 13 illustrates the outcome of the use of the slots 215 and 220. As shown, two nulls may be obtained at S21 (relation between the output wave to the input wave (i.e., gain)) for the LTE band. Therefore, those skilled in the art will understand that the isolation is improved between the LTFM 205 and the LTFM 210 across the entire band. Furthermore, a desired correlation coefficient may be obtained. In contrast from the move from −7 dB to −5 dB without the slots 215 and 220 on the printed balun 200, the use of the slots 215 and 220 on the printed balun 200 results in a move from −10 dB to −12 dB. Consequently, without the slots 215 and 220, the correlation coefficient is 0.744 at 710 MHz and 0.454 at 770 MHz. In contrast, with the slots 215 and 220, the correlation coefficient is 0.367 at 710 MHz and 0.0897 at 770 MHz. It should be noted that the slots 215 and 220 being disposed along the ground plane is only exemplary. For example, in a further embodiment, FIG. 14 shows the slots 215 and 220 disposed perpendicularly to the ground plane. Those skilled in the art will understand that the above results may also be obtained using this further embodiment.

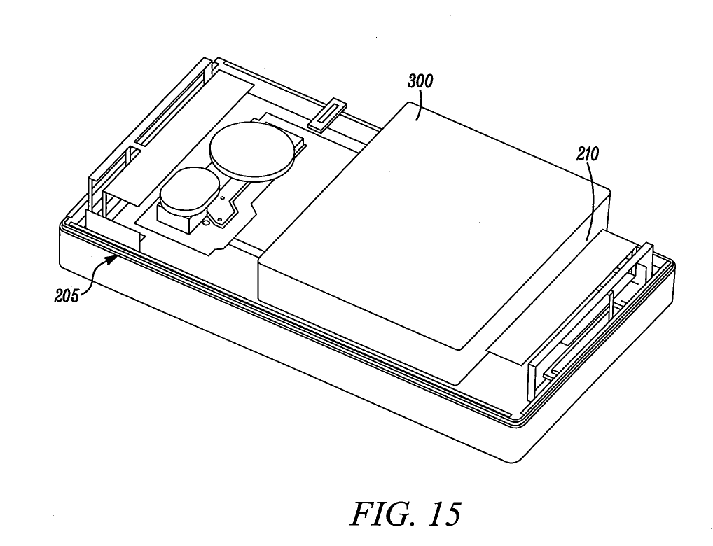

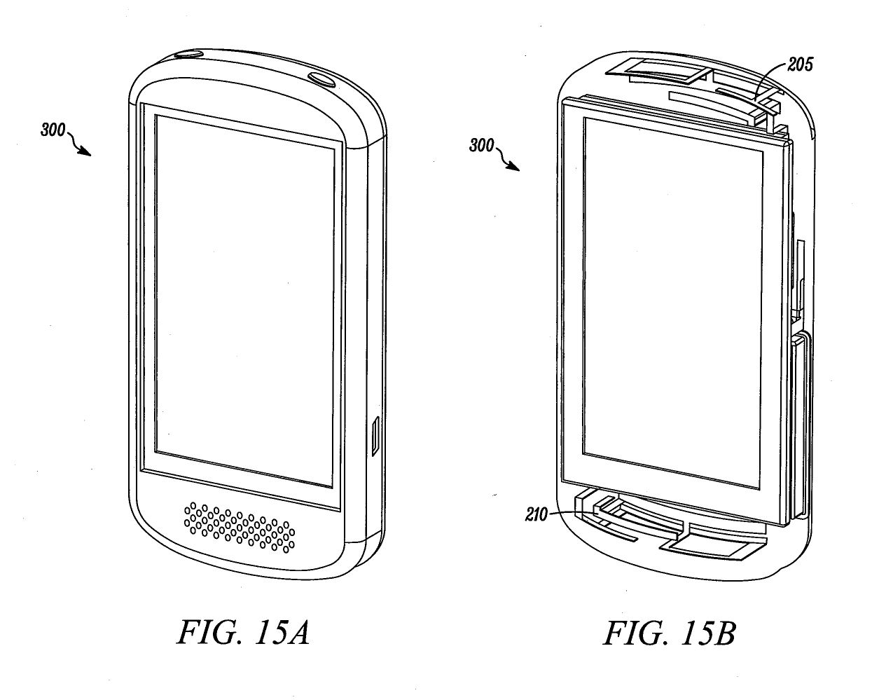

FIG. 15 shows a mobile device 300 that includes the LTFM 205 and the LTFM 210. Specifically, FIG. 15 illustrates the incorporation of the printed balun (not shown) within a frame of the mobile device 300. In a preliminary example, the implementation of the LTFM 205 and 210 with a mobile device 300 may simulate the needs to support the bands 3G-EVDO and LTE for wireless communications that the mobile device 300 may be configured to perform. For example, the 3G-EVDO may function at a frequency range between 824 MHz and 894 MHz and/or between 1850 MHz and 1990 MHz. In another example, the LTE may function according to parameters for data transfers. In a third example, the mobile device may be configured and adapted for further wireless communications such as GPS which may function at a frequency of 1575.42 MHz.

FIGS. 15A and 15B show the mobile device 300 of FIG. 15 that includes the LTFM 205 and the LTFM 210. Furthermore, FIGS. 15A and 15B illustrate the functionality of the LTFM 205 and the LFTM 210 with regard to wireless LTE protocol. FIG. 15A shows how the LTFM 205 and the LTFM 210 are incorporated within the casing of the mobile device 300. FIG. 15B shows the orientation of the LTFM 205 and the LTFM 210 as incorporated within the casing of the mobile device 300. Furthermore, according to the exemplary embodiment, the LTFM 205 may be used as an auxiliary antenna for the LTE protocol while the LTFM 210 may be used as a main antenna for the LTE protocol.

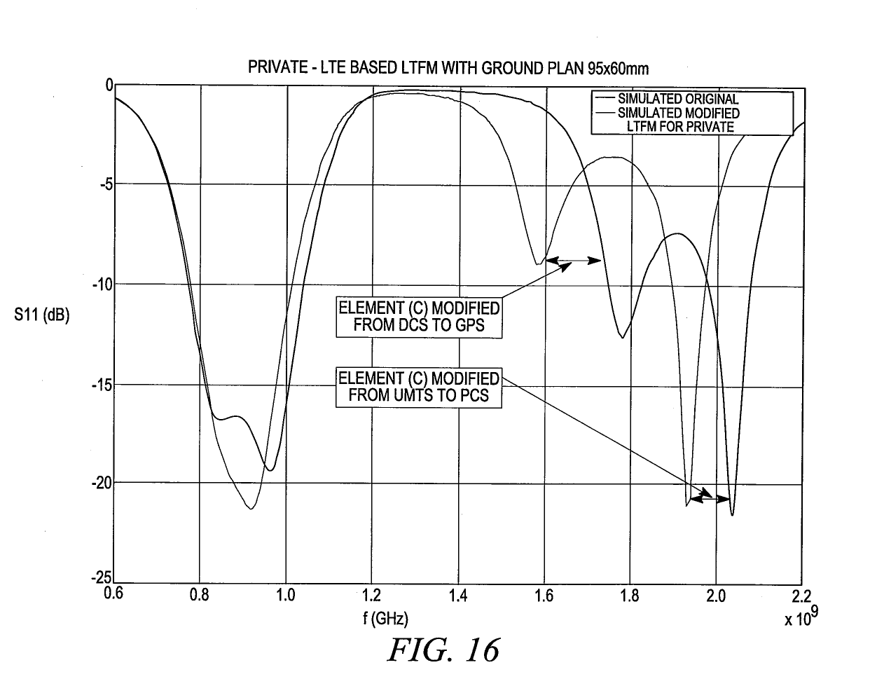

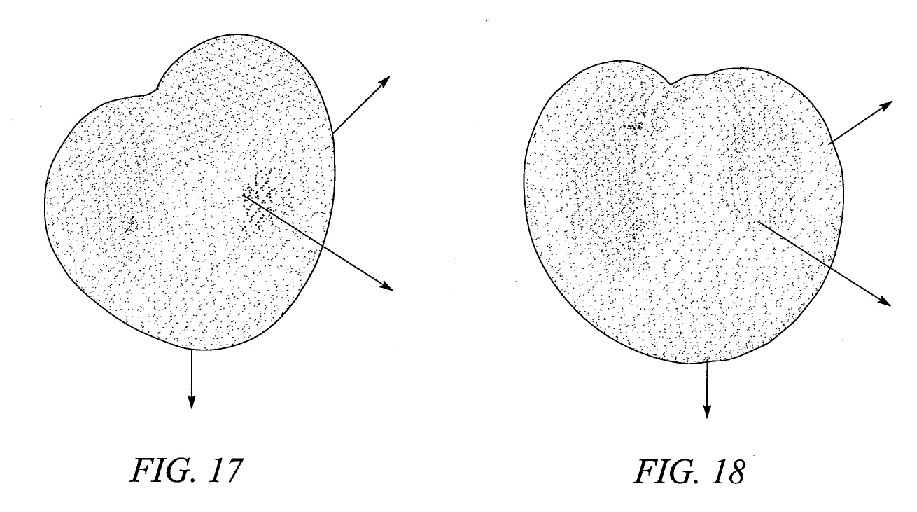

Referring to FIG. 1 showing the first element 105, the second element 110, the third element 115, and the fourth element 120 for the LTFM 100, the LTFM 205 and the LTFM 210 may also include these elements. Therefore, the elements 115 and the elements 120 for the LTFM which generate the higher bands may shift to GPS and PCS through adding 4.3 mm and 6.5 mm, respectively. FIG. 16 shows a return-loss outcome for the above requirement. Specifically, for a LTE based LTFM with a ground plane having dimensions of 95 mm by 60 mm, the S11 in dB may be measured as a function of frequency measured in GHz. In particular for the GPS frequency, FIG. 17 shows a three dimensional pattern at 1570 MHz for a linear case having an efficiency of 85% with an average gain of −0.7 dBi. FIG. 18 shows a three dimensional pattern at 1570 MHz for a right hand circular polarization (RHCP) case having an efficiency of 42.65% with an average gain of −3.7 dBic.

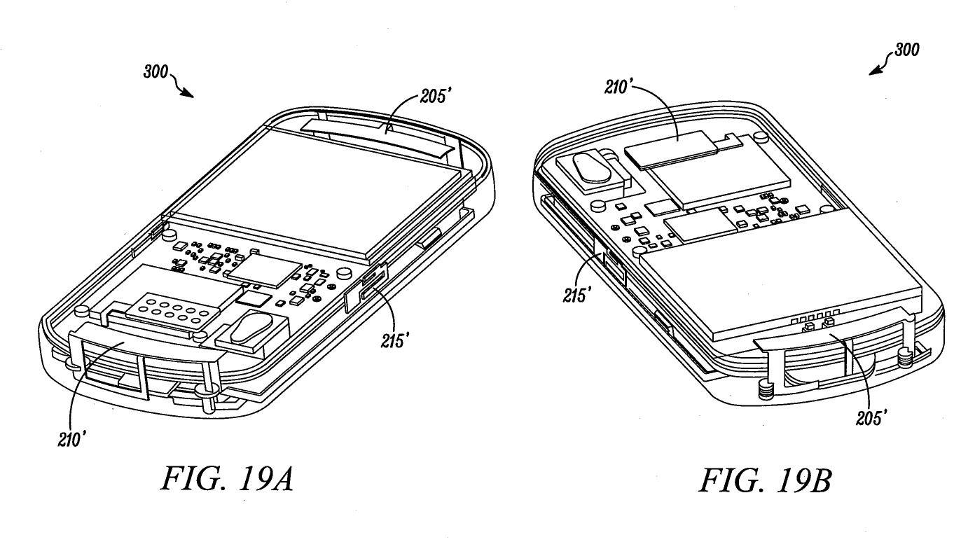

FIGS. 19A and 19B show a perspective view of the mobile device 300 with a modified printed balun including two LTFMs 205′ and 210′ with a further antenna component 215′. According to this exemplary embodiment, the modified printed balun may include the LTFM 205′ and the LTFM 210′. However, the elements used for the bands of the WiFi protocol and the BT protocol may be disposed at a different position on the printed balun. Specifically, the LFTM 205′ and the LTFM 210′ may include elements disposed at top and bottom ends of the mobile device 300 for the bands of the LTE protocol while the further antenna components 215′ may include the elements for the bands of the WiFi protocol and the BT protocol at side of the mobile device 300. FIG. 19A shows the further component 215′ at one side of the mobile device 300 while FIG. 19B shows the further component 215′ also being disposed at the other side of the mobile device 300. As described with reference to FIG. 15A, the LTFM 205′ may be used as an auxiliary antenna for the LTE protocol while the LTFM 210′ may be used as a main antenna for the LTE protocol.

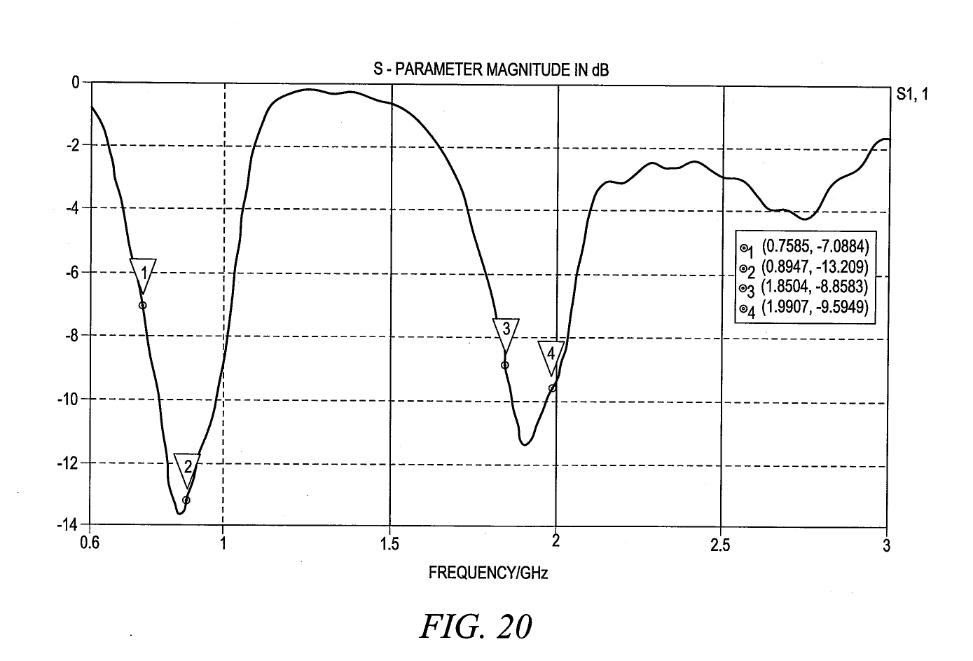

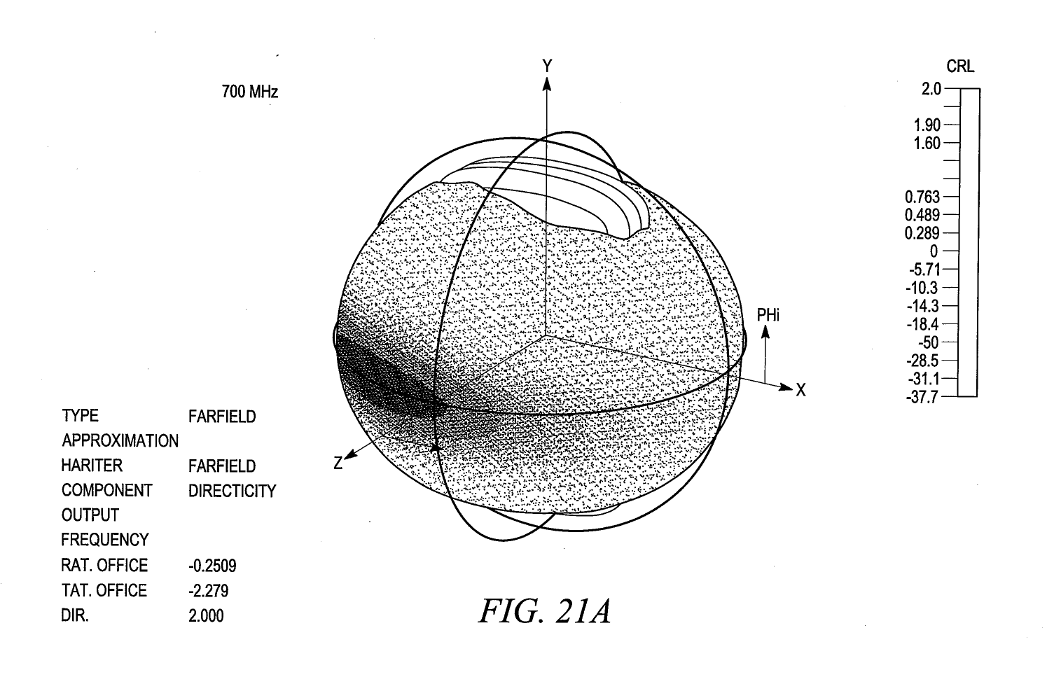

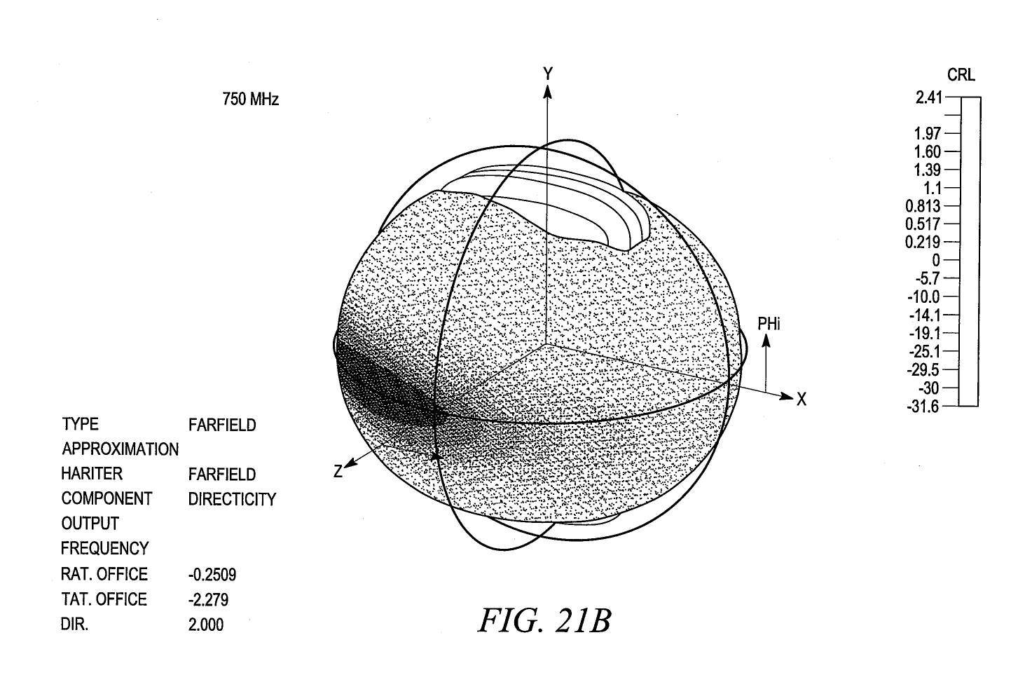

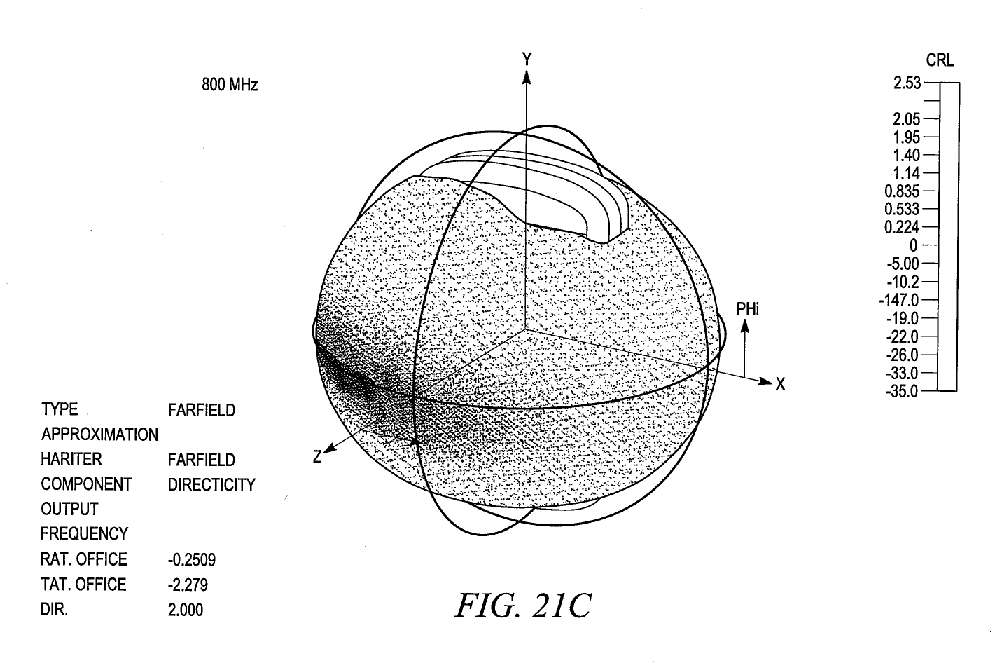

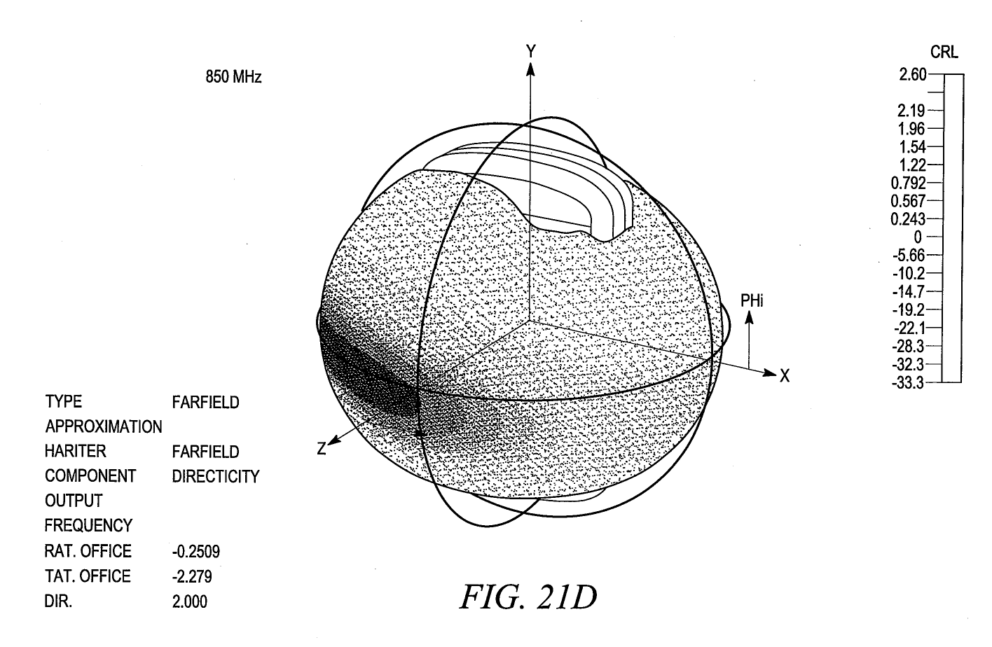

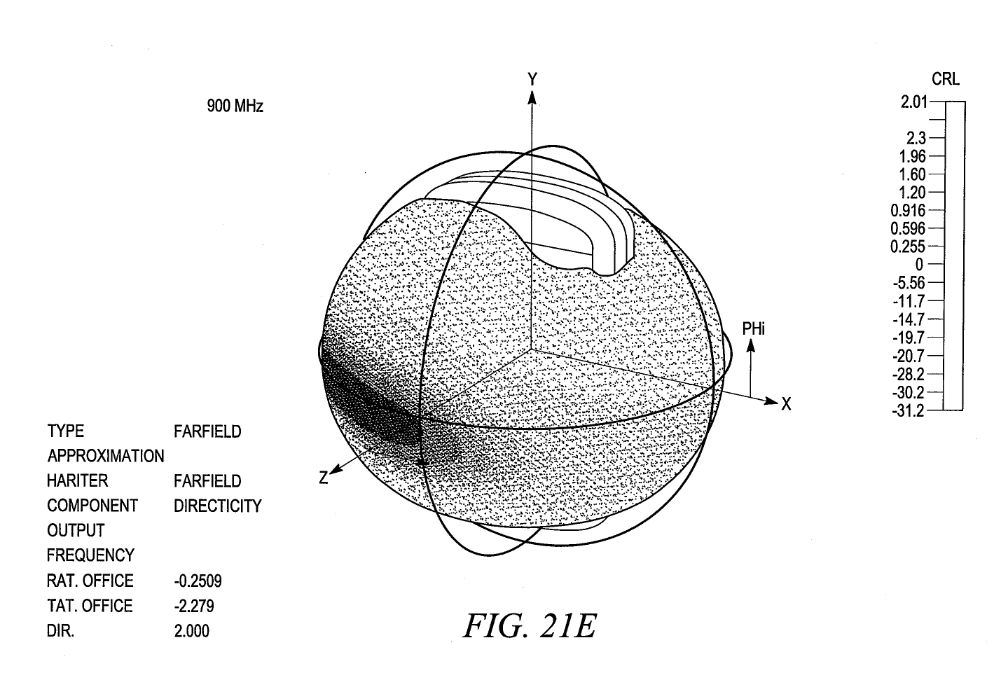

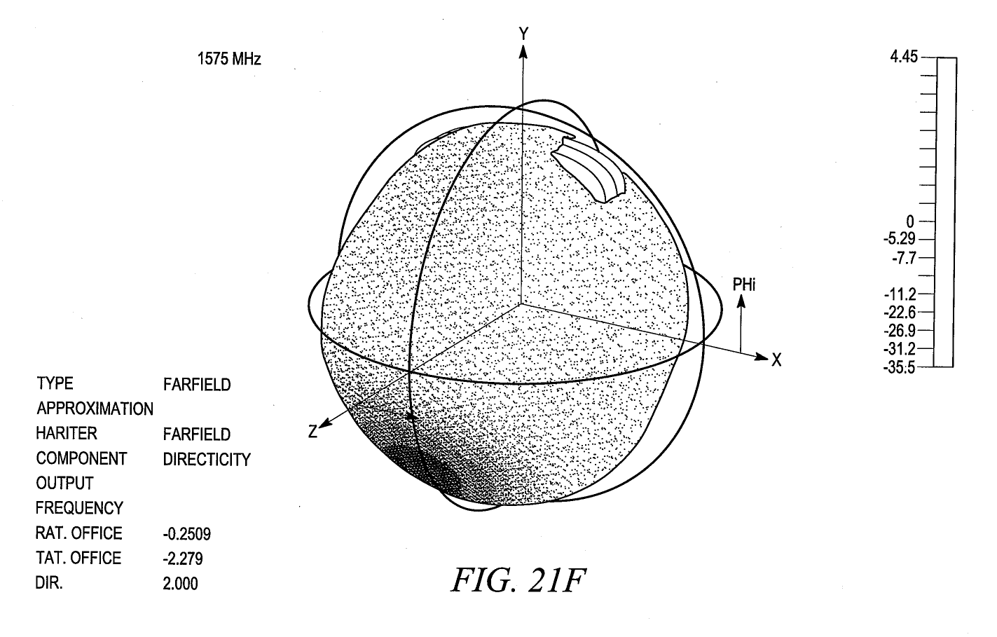

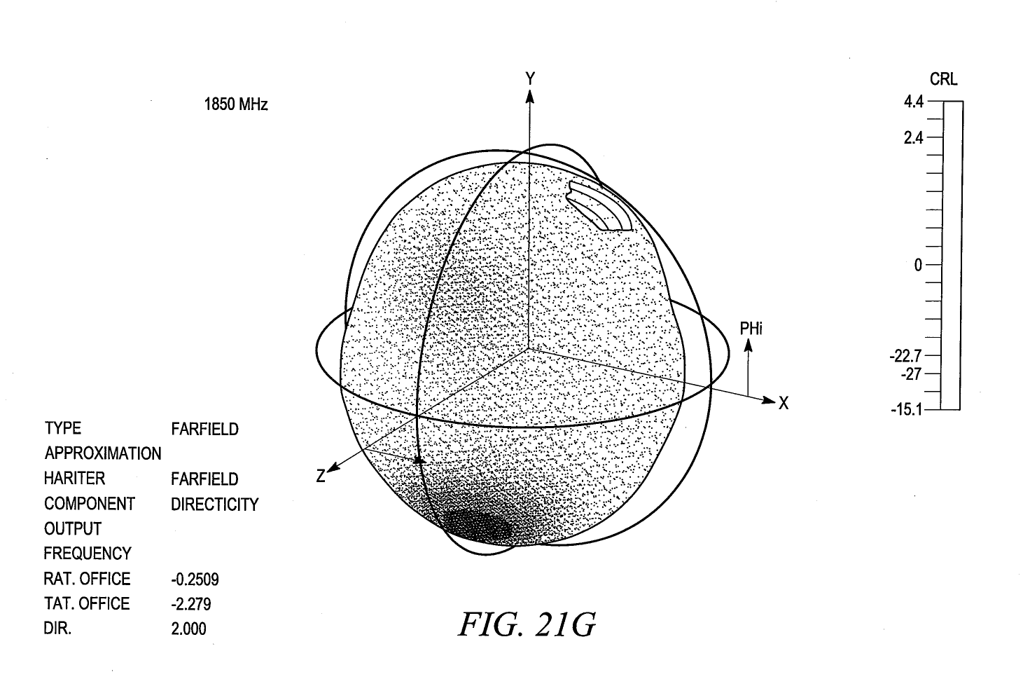

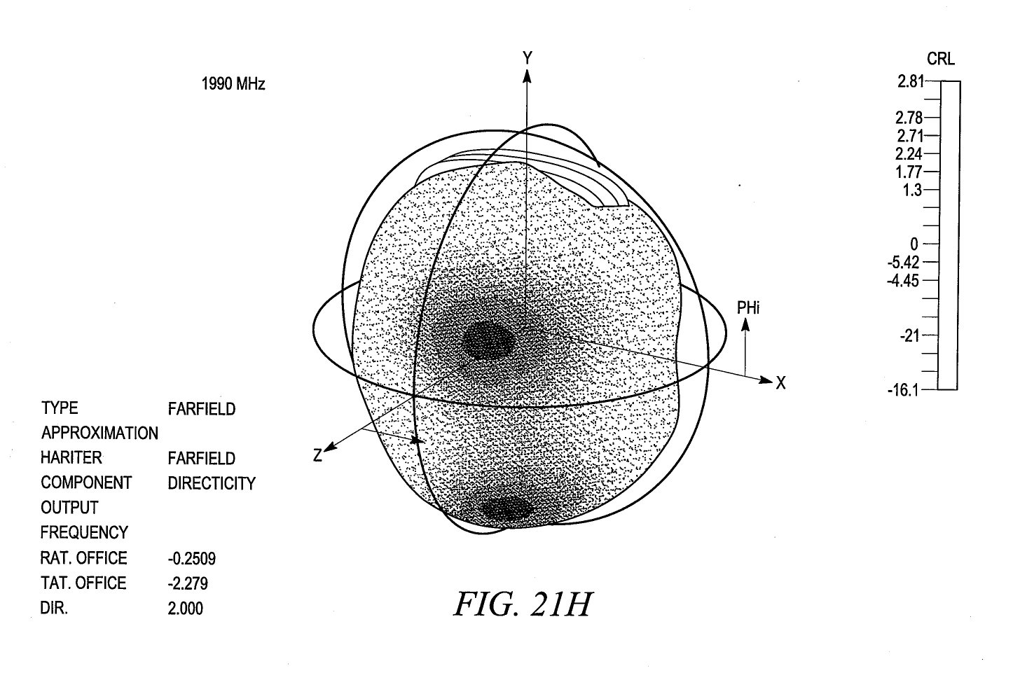

FIG. 20 shows a measurement of a S-parameter magnitude for the modified printed balun of FIG. 19 according to an exemplary embodiment. Specifically, the measurement illustrates the S-parameter in dB as a function of frequency in GHz. FIGS. 21A-H show a three dimensional radiation pattern for the modified printed balun of FIG. 19 at various wavelengths according to an exemplary embodiment. Specifically, FIG. 21A illustrates the radiation pattern at 700 MHz; FIG. 21B illustrates the radiation pattern at 750 MHz; FIG. 21C illustrates the radiation pattern at 800 MHz; FIG. 21D illustrates the radiation pattern at 850 MHZ; FIG. 21E illustrates the radiation pattern at 900 MHz; FIG. 21F illustrates the radiation pattern at 1575 MHz; FIG. 21G illustrates the radiation pattern at 1850 MHz; and FIG. 21H illustrates the radiation pattern at 1990 MHz.

The exemplary embodiments describe a loading of a twisted folded monopole that includes four elements. The first and second elements are used for supporting the lower band while the third and fourth elements are used for supporting the higher band. Using a configuration in which a first LTFM is disposed on a first side of a ground plane and a second LTFM is disposed on a second opposite side of the ground plane, various simulations show the isolation properties as well as the correlation coefficient for the LTFM.

The LTFM with a volume of 61 mm by 17 mm by 12 mm obtains remarkable bandwidth of 31.6% (262 MHz) in the lower band and 23.7% (460 MHz) in the higher band. The LTFM having the above dimensions also acquire remarkable radiation performance for different types of ground planes having various dimensions. The LTFM enables flexible adjustment for desired bands through the four elements since each element presents fundamental frequency of physical length. The flexibility of the LFTM also enables a smaller design using capacitive loading to decrease an overall volume.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A loading of a twisted folded monopole (LTFM), comprising:
a first antenna portion;
a second antenna portion, the first and second antenna portions mutually coupled to support a lower band for wireless communications;
a third antenna portion; and
a fourth antenna portion, the third and fourth antenna portions generating self resonance in a higher band for wireless communications.

2. The LTFM of claim 1, wherein the lower band is 31.6% bandwidth (262 MHz).

3. The LTFM of claim 1, wherein the higher band is 23.7% bandwidth (460 MHz).

4. The LTFM of claim 1, wherein the first, second, third, and fourth antenna portions are based on a quarter wavelength.

5. The LTFM of claim 1, wherein the wireless communications include long term evolution (LTE), Global System for Mobile Communications (GSM) 850, GSM900, Data Coding Scheme (DCS) 1800, Partitioning Communication System (PCS) 1900, and Universal Mobile Telecommunications System (UMTS) 2100.

6. The LTFM of claim 1, wherein the mutual coupling of the first and second antenna portions substantially generates a desired bandwidth in the lower band.

7. The LTFM of claim 1, wherein the first, second, third, and fourth antenna portions are configured and adapted to be incorporated in a frame of a mobile device.

8. The LTFM of claim 1, wherein the first, second, third, and fourth antenna portions are made using at least one of a stamping-tin, a flex printed circuit (FPC), a laser direct structure (LDS), tin from nickel-silver, and capacitance loading.

9. The LTFM of claim 1, wherein the first antenna portion is a J antenna, the third antenna portion is an inverted L antenna, and the second and fourth antenna portions are folded monopoles.

10. The LTFM of claim 1, wherein the first, second, third, and fourth antenna portions each generate a part of a complete bandwidth of the monopole.

11. A mobile device, comprising:
an antenna including:
a first loading of a twisted folded monopole (LTFM);
a second LTFM; and
a ground plane disposed between the first and second LTFM,
wherein the first and second LTFM each include a first antenna portion, a second antenna portion, a third antenna portion, and a fourth antenna portion, the first and second antenna portions mutually coupled to support a lower band for wireless communications, the third and fourth antenna portions generating self resonance in a higher band for wireless communications.

12. The mobile device of claim 11, wherein the lower band is 31.6% bandwidth (262 MHz).

13. The mobile device of claim 11, wherein the higher band is 23.7% bandwidth (460 MHz).

14. The mobile device of claim 11, wherein the antenna and the antenna portions are based on a quarter wavelength.

15. The mobile device of claim 11, wherein the ground plane includes at least two slots.

16. The mobile device of claim 15, wherein the slots are disposed one of within the ground plane and perpendicularly to the ground plane, the slots extending from the first LTFM to the second LTFM.

17. The mobile device of claim 11, further comprising:
a frame housing the antenna.

18. The mobile device of claim 11, wherein the antenna is made using at least one of a stamping-tin, a FPC, a LDS, tin from nickel-silver, and capacitance loading.

19. The mobile device of claim 11, wherein the first antenna portion is a J antenna, the third antenna portion is an inverted L antenna, and the second and fourth antenna portions are folded monopoles.

20. A LTFM, comprising:
a first transceiving means for partially supporting a lower band;
a second transceiving means for partially supporting a lower band, the first and second transceiving means mutually coupled to support the lower band for wireless communications;
a third transceiving means for partially supporting a higher band; and
a fourth transceiving means for partially supporting a higher band, the third and fourth transceiving means generating self resonance in the higher band for wireless communications.
